(19) United States
(12) Patent Application Publication
(10) Pub. No.: US 2012/0191500 A1
(43) Pub. Date: Jul. 26, 2012

(54) METHOD AND SYSTEM FOR MANAGING MEETINGS

(76) Inventors: Blake BYRNES, Atlanta, GA (US); Brett COOPER, Atlanta, GA (US); Richard MAKERSON, Atlanta, GA (US); Jeffrey STEINKE, Atlanta, GA (US)

(21) Appl. No.: 13/324,221

(22) Filed: Dec. 13, 2011

Related U.S. Application Data
(60) Provisional application No. 61/425,080, filed on Dec. 20, 2010.

(51) Int. Cl. G06Q 10/06

(52) U.S. Cl. 705/7.19

(57) ABSTRACT

A method for organizing meeting information, comprising: receiving information about a meeting utilizing a computer; creating a meeting space to represent the meeting, utilizing the computer; integrating known information about the meeting in the meeting space, utilizing the computer; searching for other information about the meeting utilizing the computer; adding any additional information found about the meeting in the meeting space, utilizing the computer; and managing the meeting space utilizing the computer.

### CROSS REFERENCE TO RELATED APPLICATIONS

This application claims the benefit of U.S. Provisional Patent Application No. 61/425,080, filed Dec. 20, 2010, which is incorporated by reference in its entirety.

### BRIEF DESCRIPTION OF THE DRAWINGS

FIG. 1 illustrates a system for organizing meeting information, according to one embodiment.

FIG. 2 illustrates a method for organizing meeting information, according to one embodiment.

FIG. 3 is a screen shot showing how meeting requests can be integrated with a meeting organization application, according to one embodiment.

FIG. 4 is a screen shot showing a user's action items, according to one embodiment.

FIGS. 5A-5C are screen shots showing how meeting notes can be captured using a custom meeting space, according to one embodiment.

FIG. 6 is a screen shot illustrating how notes can be captured during the course of a meeting, according to one embodiment.

FIG. 7 is a screen shot illustrating a system for timing a meeting, according to one embodiment.

FIG. 8 is a screen shot illustrating a reminder email that can be sent to a user, according to one embodiment.

FIG. 9 is a screen shot illustrating how information captured for a meeting can be exported, according to one embodiment.

FIG. 10 is a screen shot illustrating using meeting metrics and data to improve individual meeting effectiveness, according to one embodiment.

FIG. 11 is a screen shot illustrating several action item planning and completion trends, according to one embodiment.

FIG. 12 is a screen shot illustrating where time is being spent, according to one embodiment.

FIG. 13 is a screen shots illustrating using meeting metrics and data to improve team meeting effectiveness, according to one embodiment.

FIGS. 14A-C are screen shots illustrating how results of a meeting can be analyzed, according to one embodiment.

FIG. 15 is a screen shot illustrating how the planning of meetings across a team can be analyzed, according to one embodiment.

FIG. 16 is a screen shot illustrating how usage of the meeting organization application can be analyzed, according to one embodiment.

FIG. 17 is a screen shot illustrating how a team may be summarized by the aggregated number of meetings and actions, according to one embodiment.

FIGS. 18-21 illustrate details related to organizing meeting information, according, to one embodiment.

### DESCRIPTION OF EMBODIMENTS OF THE INVENTION

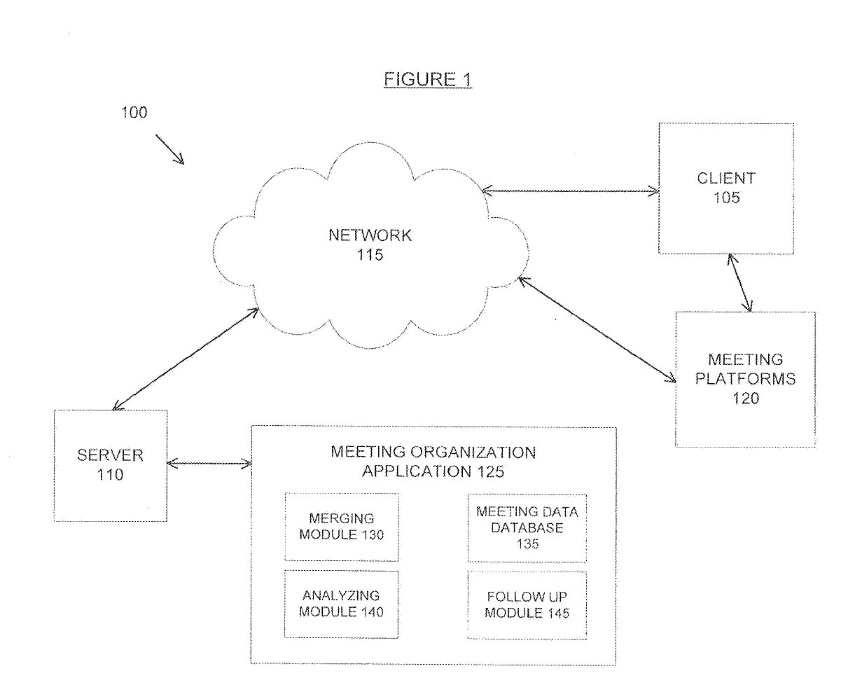

FIG. 1 illustrates a system 100 for organizing meeting information, according to one embodiment. FIG. 1 comprises: at least once client computer 105 connected to at least one server computer 110 over at least one network 115. The client computer 105 may also be represented by an email containing the meeting planning details. The server computer 105 can communicate with at least one meeting organization application 125, which can communicate with various meeting platforms 120. The meeting organization application 125 can include: at least one merging module 130; at least one analyzing module 140, at least one meeting data database 135; or at least one follow up module 145; or any combination thereof.

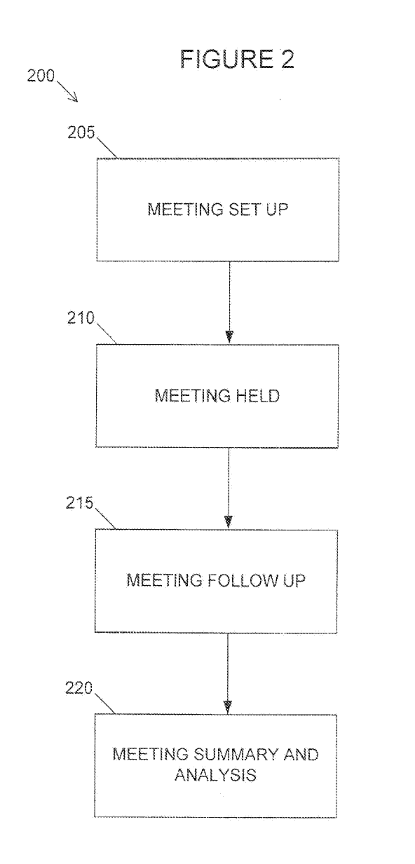

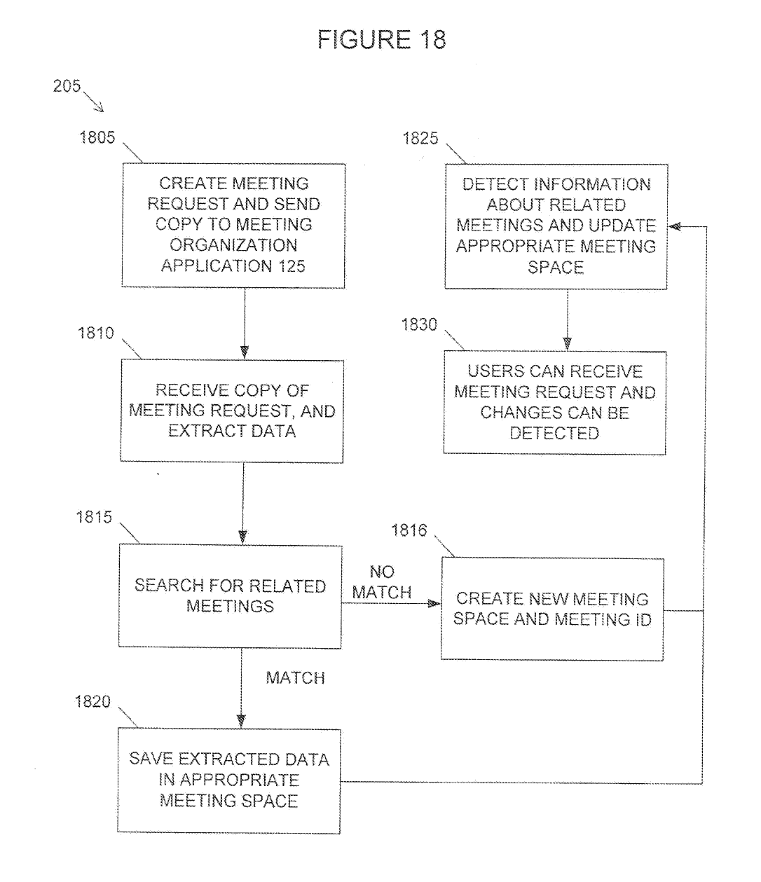

FIG. 2 illustrates a method 200 for organizing meeting information, according to one embodiment. In 205, all information about a particular meeting (“meeting A”) can be received and all known information about the meeting can be integrated into a meeting space for the particular meeting (“meeting space A”). In 210, the meeting can take place. In 215, the information in the meeting space can he used to follow up and/or rate the meeting. In 220, the metrics related to information from the meeting and/or other meetings can be summarized and analyzed. More details on 205-220 are provided in FIGS. 18-21, which are described below.

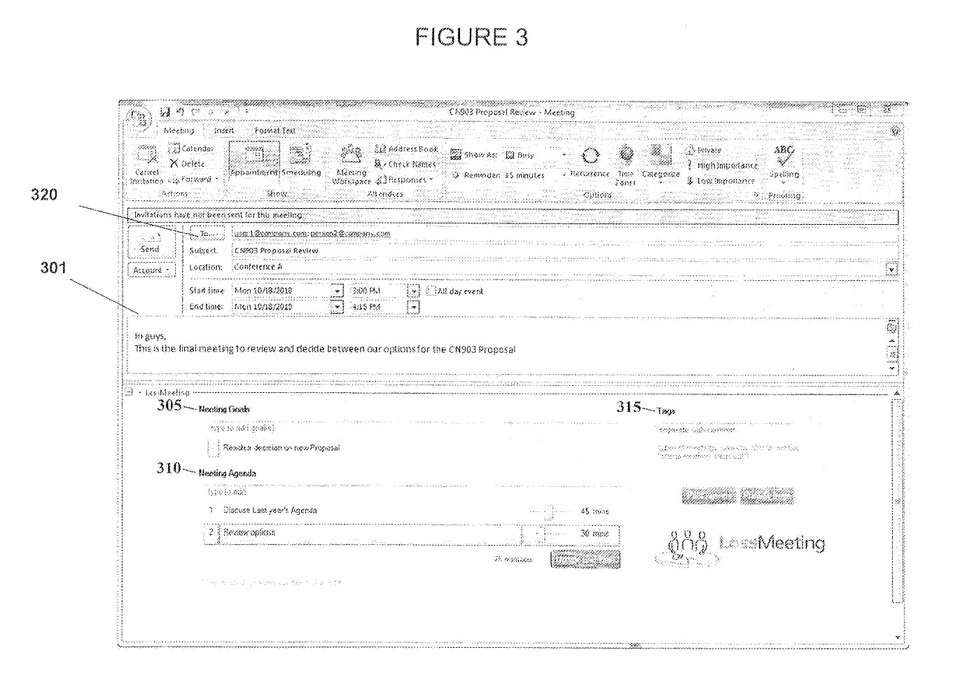

FIG. 3 illustrates a screen shot showing how Microsoft Outlook meeting requests can be integrated with meeting organization application 125 to allow a user to generate goals, an agenda, or tags for a meeting, or any combination thereof, according to one embodiment. Microsoft Outlook is used in this example and subsequent examples, but embodiments of the invention may be used with other programs. The interactive interface may allow the user to at least sort, edit, add, and/or remove entries to each meeting using at least drag and drop, keyboard entry, and/or visual buttons. Agenda items may be assigned a planned time using a slider or other input, and each agenda item may be summarized into a total time required for a meeting. From this total time, the system can suggest and adjust the appropriate time needed for the meeting. Generated “meeting plan” information can be formatted and included in the body of the meeting request for any recipient to view, with or without the meeting organization application 125 installed.

FIG. 3 may also be represented in the form of a “body” of a meeting request, of which the meeting organization application 125 can either forward the invitation, or add the host of the meeting organization, application 125 as an attendee on the meeting. The meeting organization application 125 can incorporate some or all of the details of the calendar item, as well as some or all of the details of the planned agenda, goals and tags in order to create and merge at least one meeting invitation into a single meeting space.

FIG. 3 also illustrates a printable meeting notes template from the meeting plan generated in the outlook plugin, according to one embodiment. The template may allow a user to take handwritten notes about at least points discussed during a meeting in 301, meeting goals 305, meeting agenda 310, tags 315, or attendance 320, or any combination thereof.

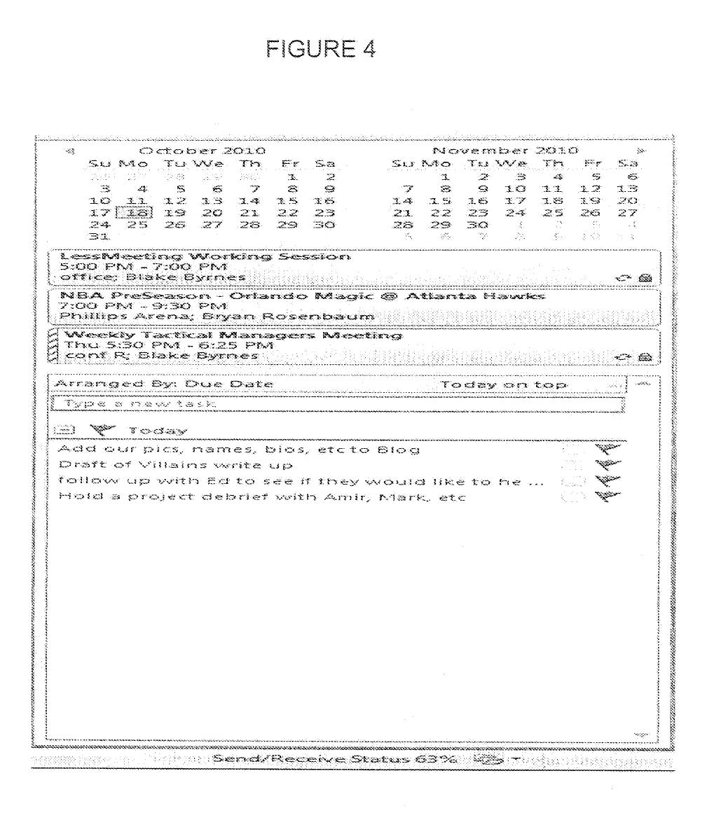

FIG. 4 is a screen shot showing how a user's action items, which may be generated during meeting notes, can be synchronized into the Microsoft Outlook tasks system, according to one embodiment. Changes to at least the action item subjects, due dates, and/or completion status may be synchronized back to the meeting organization application 125, reflecting the changes in details in both directions.

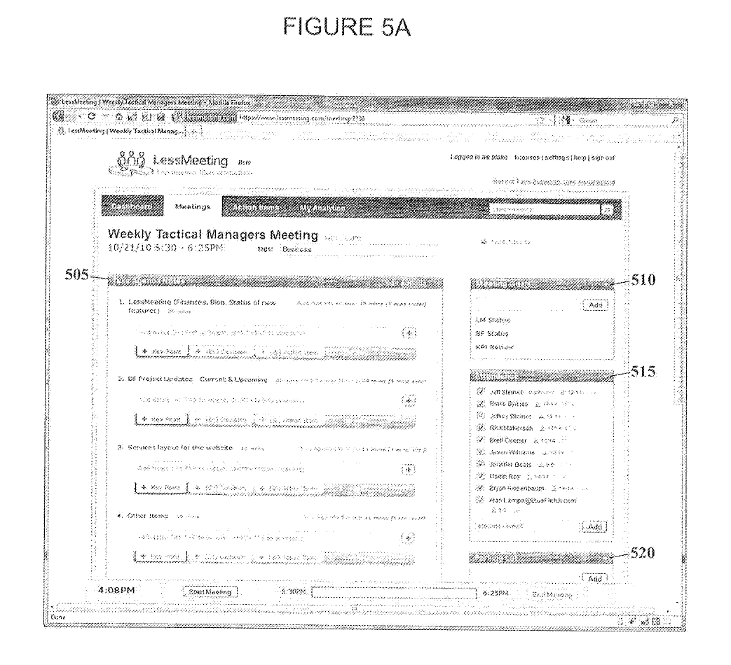

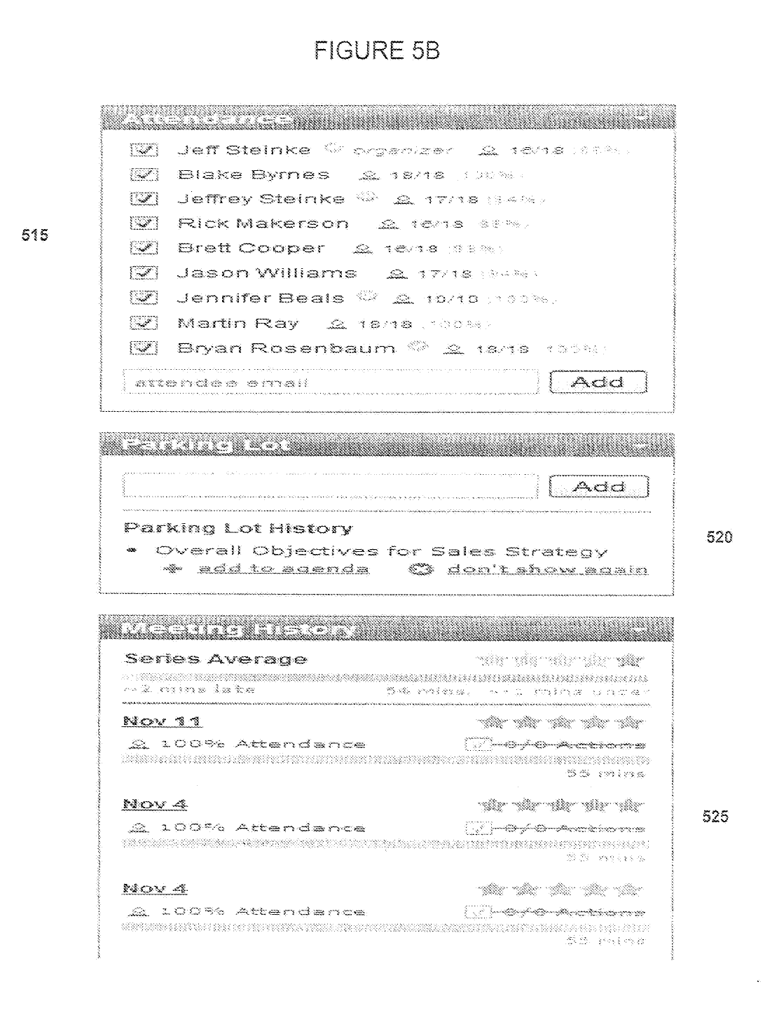

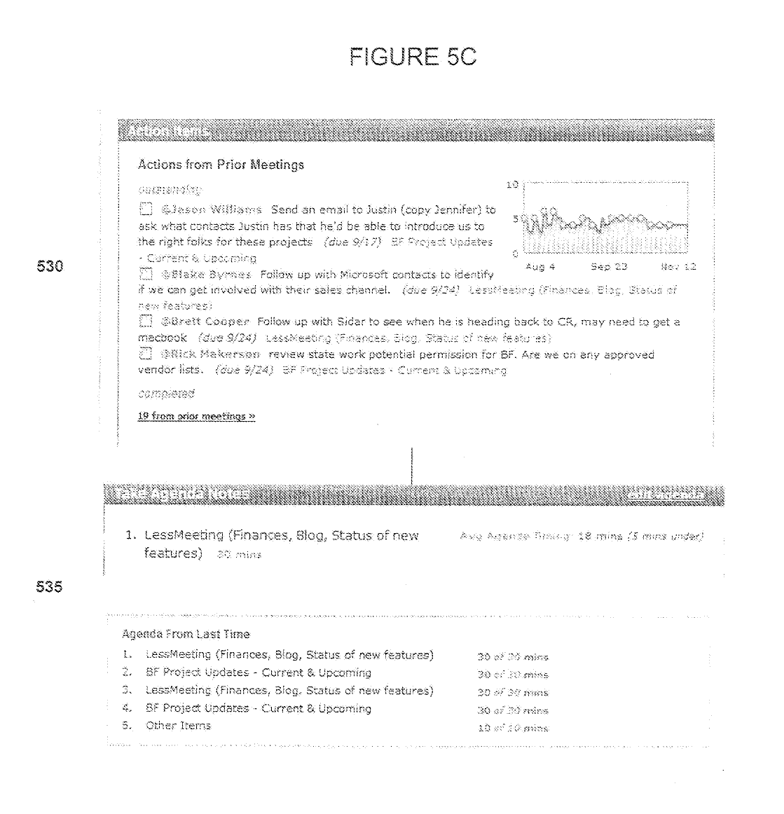

FIG. 5A-5C are screen shots showing how meeting notes can be captured using a custom meeting space generated from information synchronized from the meeting organization application 125, according to one embodiment. In 505, it is shown how notes can be captured for various agenda items. The notes can be labeled as key points, decisions, or actions items. The time spend on each agenda item, as well as the entire meeting, can also be captured. In addition, in 510, meeting goals can be captured and labeled with various statuses. In 515, the attendees at the meeting can be listed. In 520, the parking lot can be listed, which can include items discussed that were not on the agenda.

It should be noted That the meeting spaces for multiple meetings that may be part of a recurring meeting instance can be combined into a linked meeting space. Action items, parking lot items, or agenda items, or any combination thereof, in addition to other items, may be able to be reused and redisplayed across meetings. For example, in 535 of FIG. 5C, agenda items 505 may be automatically copied from the last occurrence of a recurring meeting upon accessing the meeting space. In one embodiment, agenda items can display the time needed during the last occurrence. As shown in FIG. 5C, in 530, action items from some or all previous occurrences of the recurring meeting can be shown as outstanding or completed. In addition, meeting attendance across some or all occurrences in the recurring meeting may be displayed in 515, and attendees may be added or removed from future occurrences. A summary can also be displayed of the timing and/or ratings for prior occurrences in the recurring meeting in 525. Parking lot items from prior meetings can be elevated to agenda items for the Current meeting in 520.

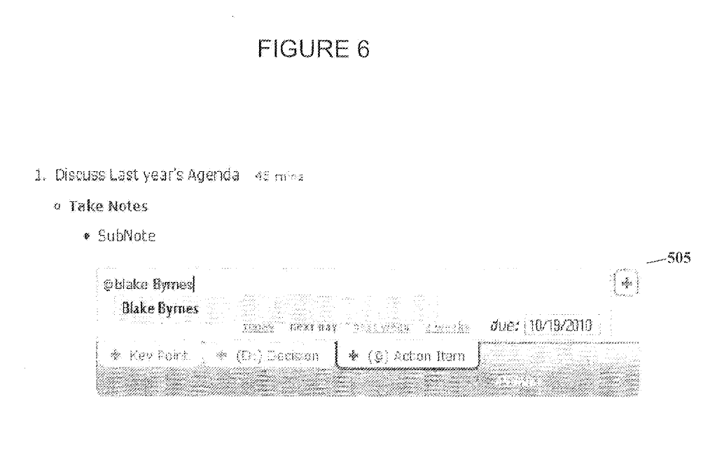

FIG. 6 is a screen shot illustrating how notes can be captured during the course of a meeting, according to one embodiment. In 505, users can capture structured bullets detailing decisions, key points, or action items, or any combination thereof, created during the course of a meeting. A user may input rapid notes using, for example, either keypad keys or input buttons, such as the “D” key for inputting a decision, or the “@” key to begin inputting and assigning an action item. Action items can also prompt assignment of the item from attendees of the meeting or others. The ability for users to create structured notes can also be provided, for example, by using the tab and shift tab keys to indent and un-indent the notes respectively. Some or all agenda items prepared for a meeting may generate a section of notes, and time spent capturing: notes may be timed for each section, so as to capture estimated time spent on each agenda Item.

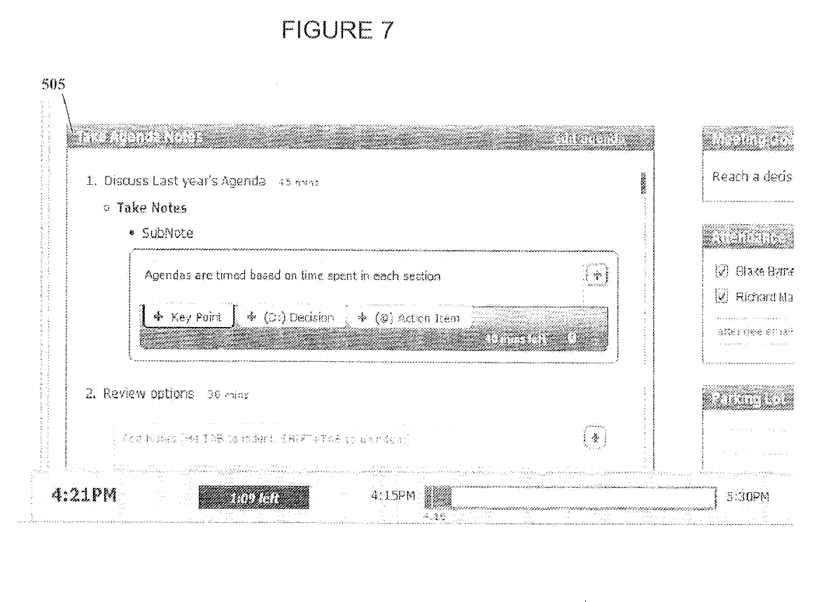

FIG. 7 is a screen shot illustrating a system for timing a meeting, as well as for displaying the details of time spent on some or all agenda items covered during the course of a meeting, according to one embodiment Upon typing notes for a meeting, a user may be prompted to start the meeting timer. Any time spent typing notes for a meeting agenda item, and/or focused on that agenda item may count towards time for that agenda item. This may allow users to move back and forth between agenda items, while still capturing overall time spent on each. FIG. 7 also illustrates how many minutes late a meeting was started, compared to the planned start time, and/or overall time spent on the meeting compared to the planned time. Colors, alerts, and/or other methods can be used to show the planned duration and expiration of the meeting and/or the planned duration of each agenda item.

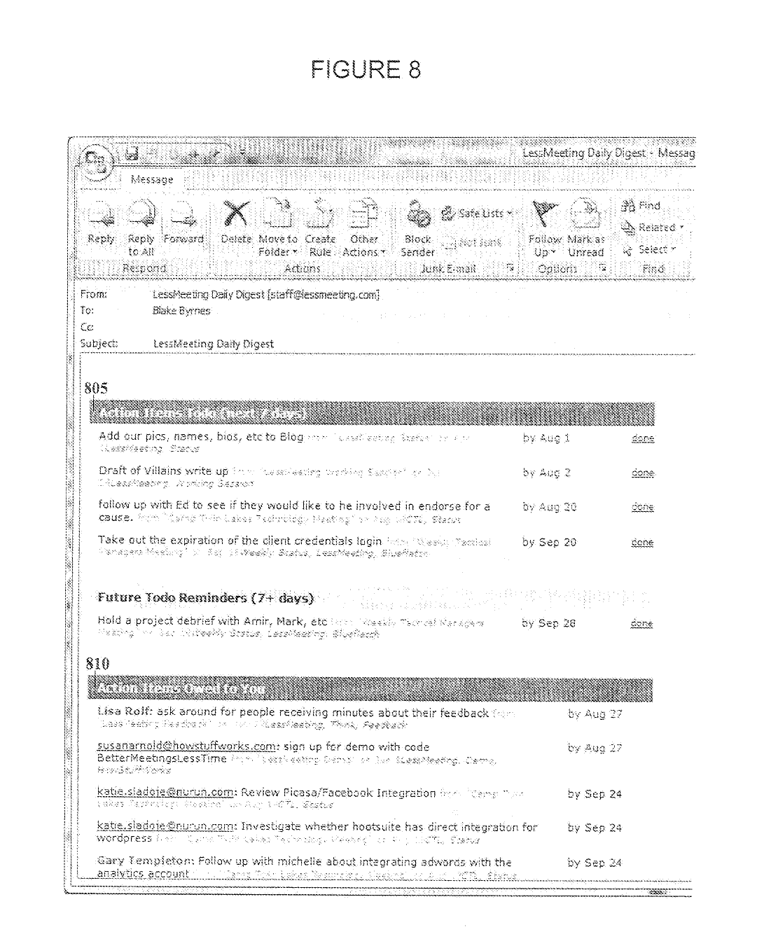

FIG. 8 is a screen shot illustrating a reminder email that can be sent to a user on a regular basis, for example daily, weekly, or monthly, or any combination thereof, according to one embodiment. As shown in 805 and 810, the reminder may summarize and format the overall queue of action items assigned and owed to users from meeting agenda action items. This may include the ability for registered and unregistered users of the system to mark action items complete. Some or all assigned action items across meetings can be combined. Based on, for example, a determined and preset amount of days remaining until the given due date, a user can be reminded, for example on a daily basis, based on the days remaining until the given due date. Users can also be informed when action items owed to them have been completed. Users can also receive reminders about a day's upcoming meetings, which may include meeting agenda items.

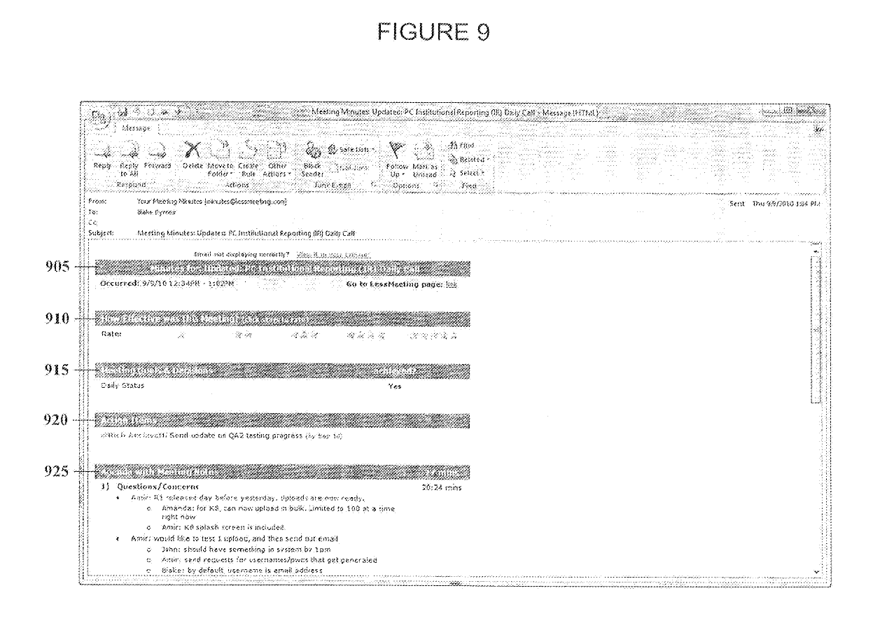

FIG. 9 is a screen shot illustrating how information captured for a meeting can be exported, according to one embodiment. This information may include: action items 920, actual time of the meeting (in 905), agenda with meeting notes 925, which can include the actual time, spent covering each agenda item, meeting goals and decisions 915, or meeting ratings 910 (e.g., where registered and unregistered users of the system can provide anonymous ratings of the meeting and/or anonymous feedback). Meeting attendance can also be sent to users.

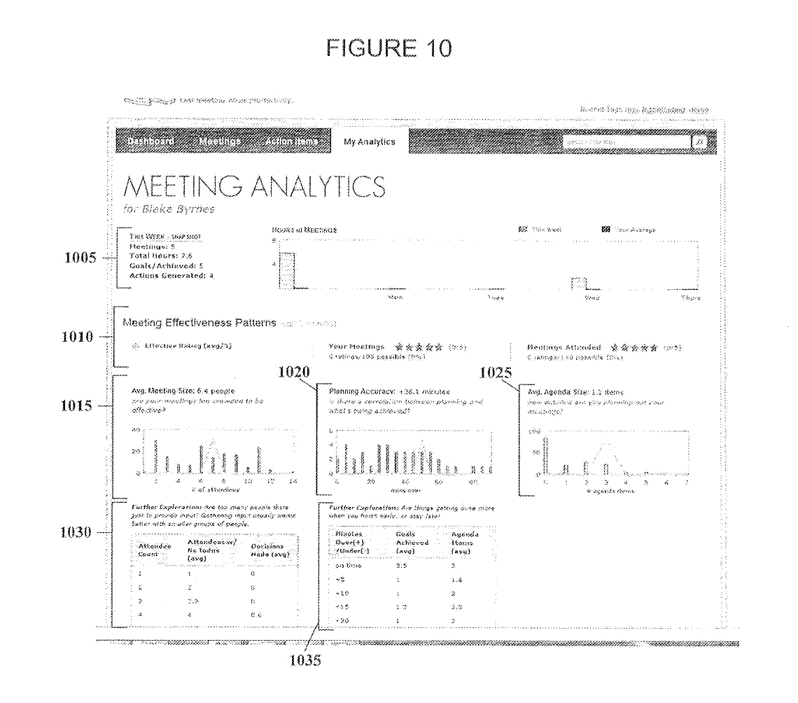

FIG. 10 is a screen shot illustrating how metrics and data around an individual's meetings can be summarized to provide analytics to measure and improve meeting effectiveness for the individual. Data can be summarized around several concepts. For example, effectiveness patterns can be shown for a variety of meeting variables. In 1005, a Snapshot of meeting information can be shown. In 1010, the effectiveness rating; and the number of attendees are shown. In addition, the following metrics can be shown: the number of agenda items 1025, the planning accuracy 1020, or average meeting size 1015, or any combination thereof. These data elements can be summarized and correlated with breakdowns showing the average achievements per data bucket. In addition, information about the percent of attendees with action items assigned corresponding with the average attendee size can be shown in 1030. Information about whether agenda items are getting done more when the meetings finish early or late can be provided in 1035. Many other metrics may be obtained from the data collected about the meetings. For example, the daily hours spent by an individual in meetings vs. the historical averages can be used to measure trends of meeting time. This data can be supplemented with the current week's workload (or the workload of another time interval) to allow a user to estimate his or her upcoming agenda and corresponding time required.

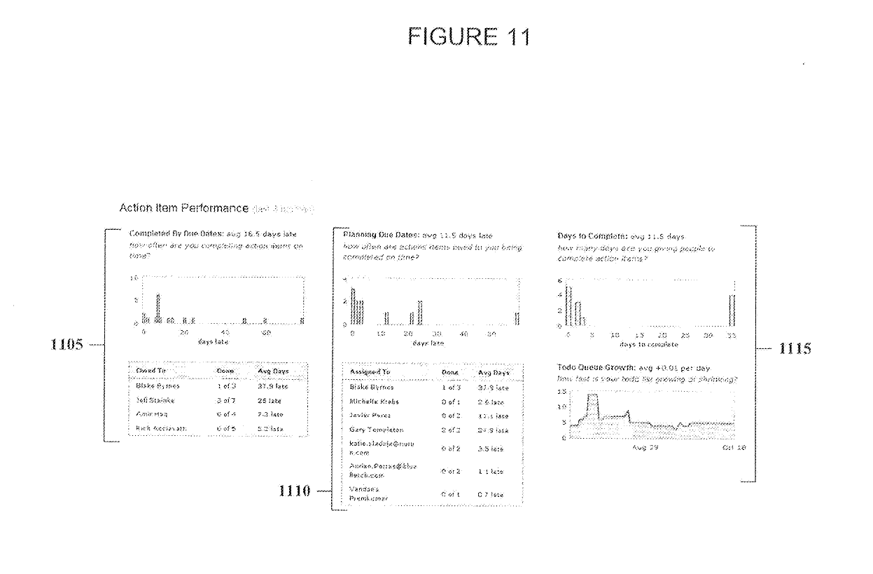

FIG. 11 is a screen shot illustrating several action item planning and completion trends, according to one embodiment. In 1105, the average days allowed for completion of action items can be shown, with a queue of actions pending completion. Action item performance for both assigned and owed action items can be shown in 1105 and 1110. In addition, in 1115, how many days an individual gives others to complete an action item can be summarized, as well as how fast a to do list is growing or shrinking.

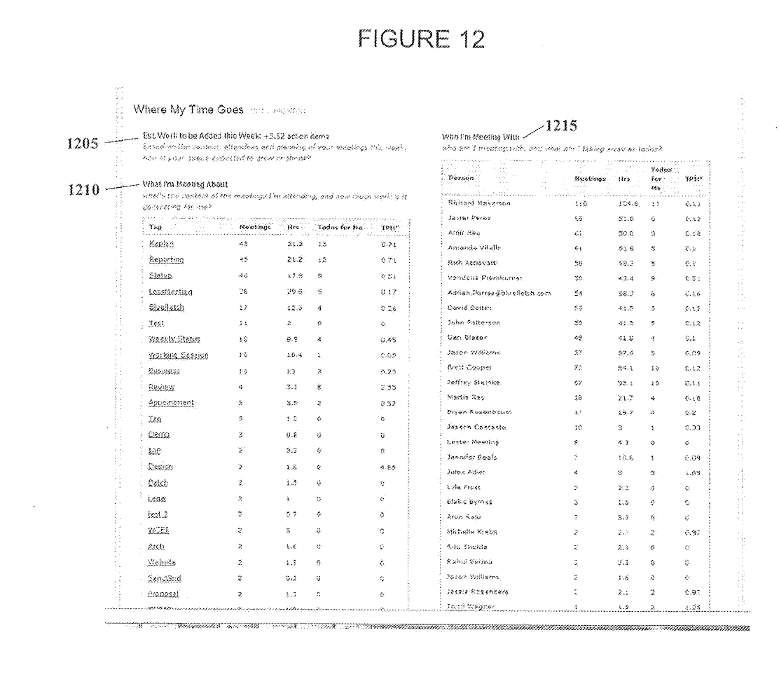

FIG. 12 is a screen shot illustrating where time is being spent, according to one embodiment. In 1210 and 1215, data can be measured and broken down into information about how many meeting hours and action items are being generated per meeting attendee, per meeting tag, or per company, or any combination thereof. This data, along with metrics surrounding agenda sizes, planning averages, or attendee sizes, or any combination thereof, may be used to estimate the tasks likely to be generated during a user's week of meetings. In addition, for each individual attending the meetings of a user, the total hours spent with that individual may be calculated. Furthermore, for each meeting with the individual, the data of all meeting spaces may be aggregated to determine how many action items are assigned to the user in shared meetings. This data can be analyzed to calculate the average action items generated per hour (or per other time interval) for an attendee. This data can also be combined with other metrics around a specified time period (e.g., the current week) for meeting attendee sizes, agenda sizes, attendees, or tags, or any combination thereof, to create an estimation of the amount of work (e.g., as shown in 1205) expected to be generated in a future time period (e.g., the upcoming week).

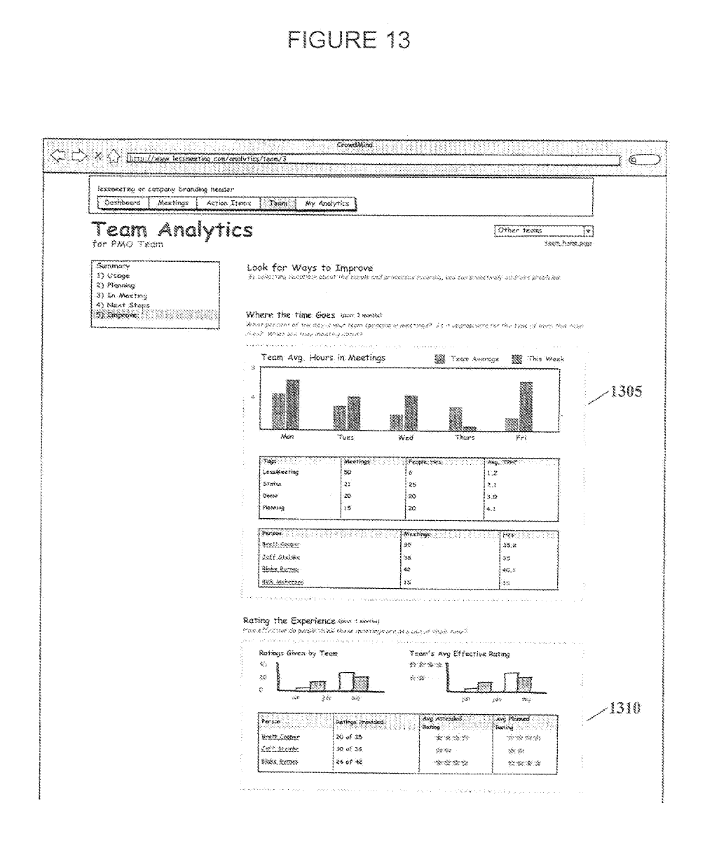

FIG. 13 is a screen shot illustrating how daily office activities such as meetings and action items can be summarized into metrics analyzing how to improve meetings (e.g., productivity and effectiveness) across a team, according to one embodiment. Teams can be created by administrators to analyze the activities of a set of team members. Teams may also be set up to filter by one or more primary tags chosen by an administrator. In 1305, for example, the time in meetings spent per tag and per person in the team of individuals can be shown. In addition, the team average hours in meetings can be shown. In 1310, the aggregate view of all anonymous ratings of meetings can be contrasted with the meeting data.

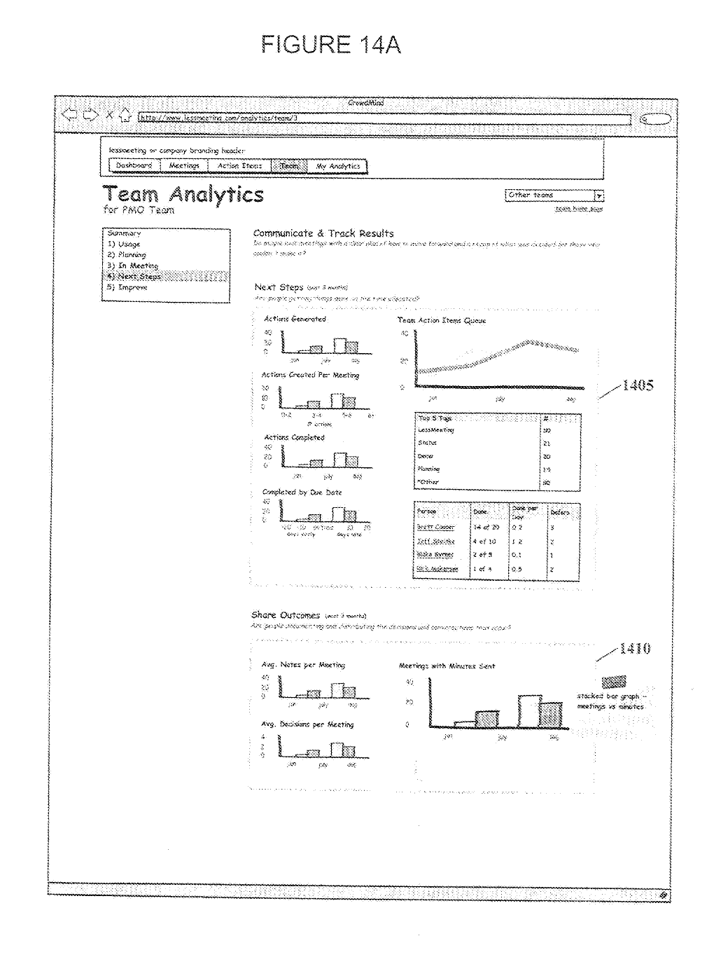

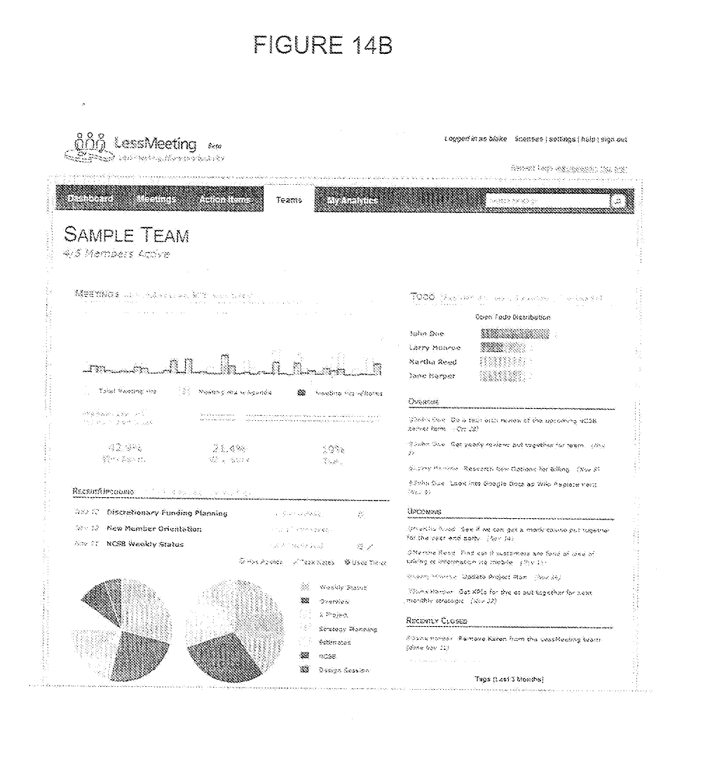

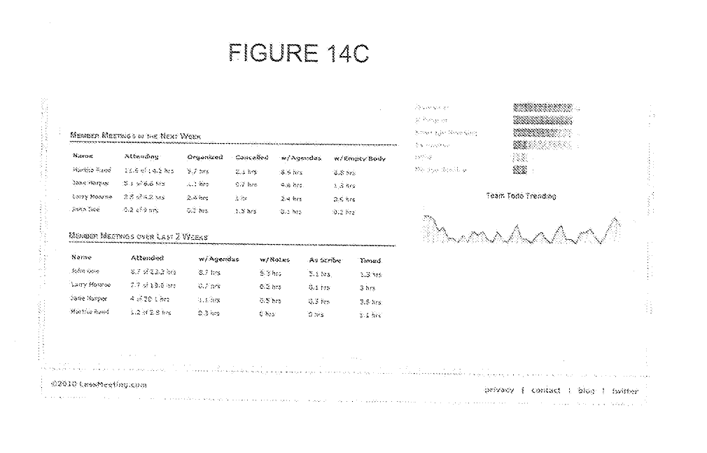

FIGS. 14A-C are screen shots illustrating how the next steps (e.g., results) of a meeting can be analyzed, according to one embodiment. For example, in 1410 of FIG. 14A, notes, decisions, and meeting minutes can be compared and contrasted. As shown in 1405 of FIG. 14A and FIGS. 14B and 14C, actions may be broken down into analysis by: days given to complete each action, number of action items generated during each month (contrasted with prior months), actions created on average in each meeting, actions completed per month, or actions completed by due date, or any combination thereof. The queue of action items owed by the team can also be put into information about frequency per tag usage and/or per individual. Meeting notes may be analyzed to measure detail of information captured and shared, including: average notes and/or decisions per meeting, notes and decisions per agenda item; or number of people receiving copies of these notes, or any combination thereof.

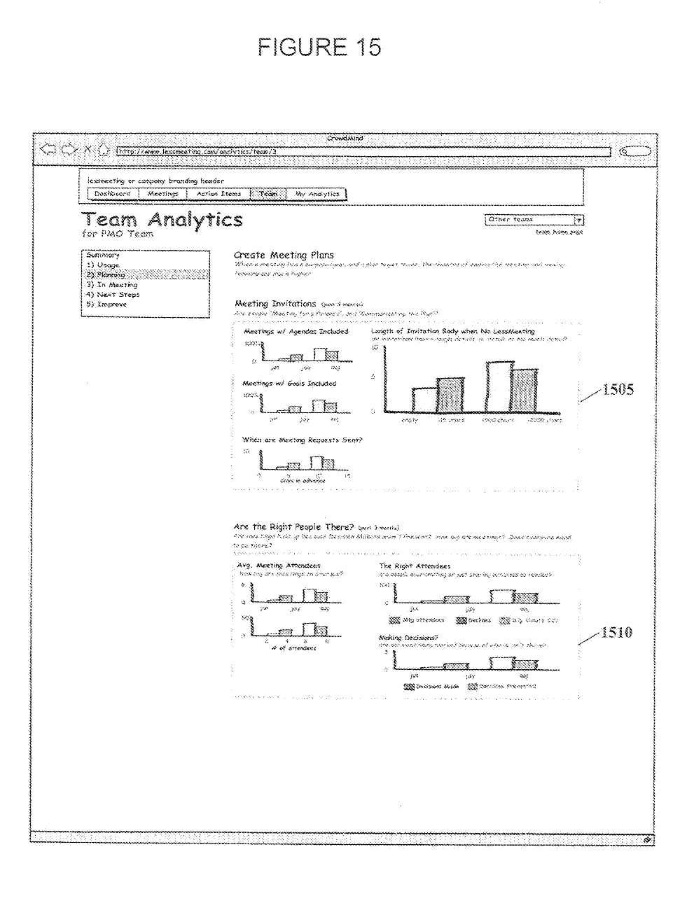

FIG. 15 is a screen shot illustrating how the planning of meetings across a team can be analyzed, according to one embodiment. Metrics may include: averages (e.g., monthly, quarterly) of meetings with agendas, meetings with goals, when meeting requests are sent, or the length of details included in the body of meeting requests, or any combination thereof, as shown in 1505. In 1510, data may be analyzed to determine the correlation of: meeting attendee invitations to attendance, accepted invitations, or decisions made and why, or any combination thereof.

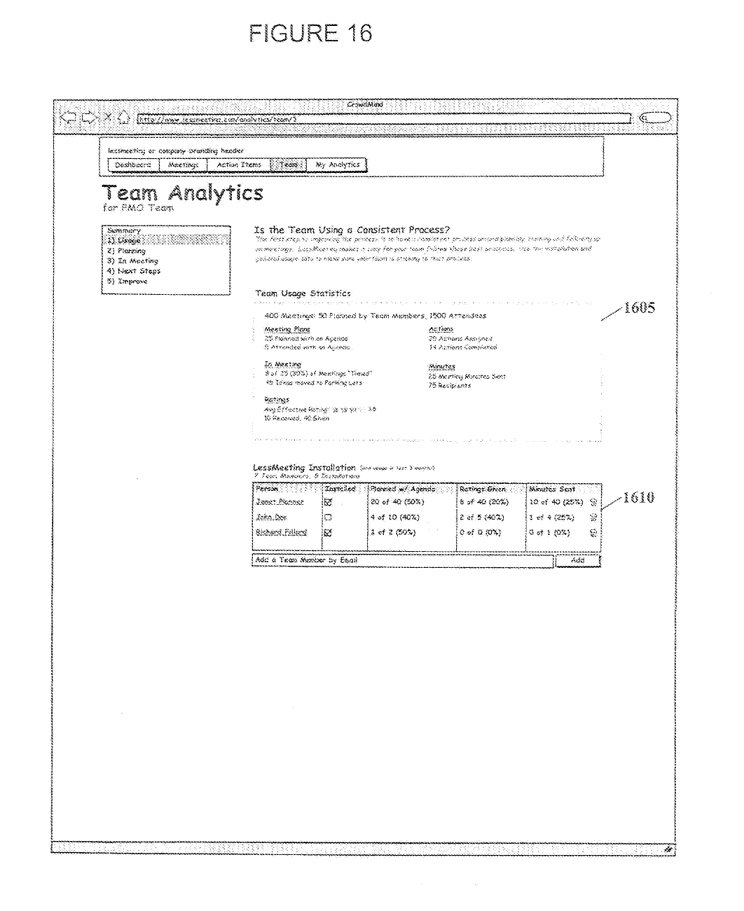

FIG. 16 is a screen shot illustrating how usage of the meeting organization application 125 can be analyzed. As shown in 1605, data may include statistics on: meeting plans, frequency of meetings timed, ratings, action items generated and/or completed, or how often meeting notes were distributed, or any combination thereof. As shown in 1610, team members can also be added and a breakdown per person of meeting organization application 125 usage can be shown.

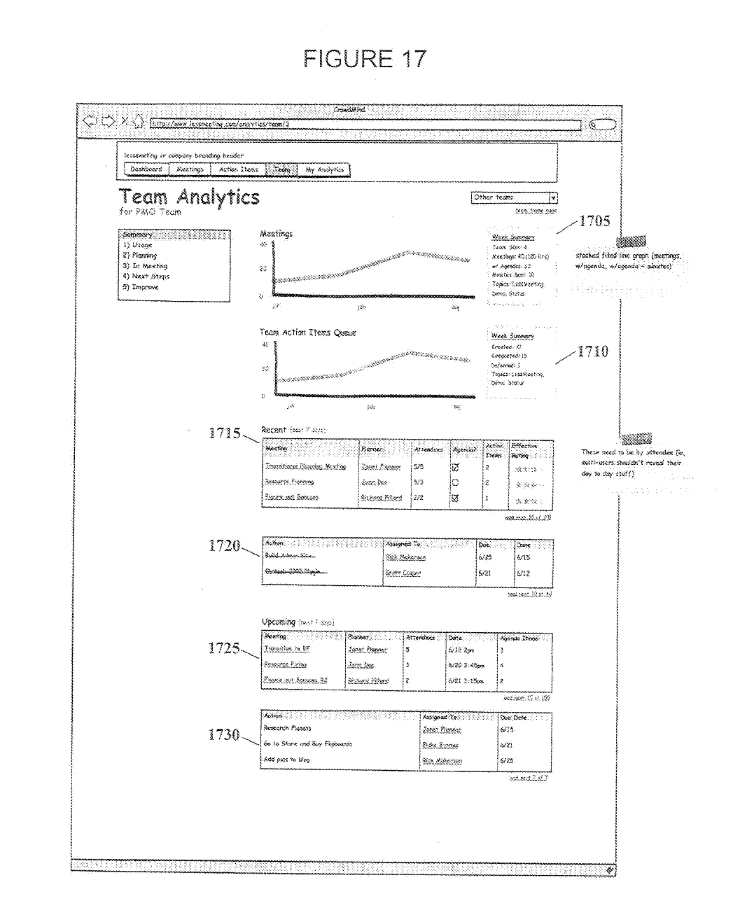

FIG. 17 is a screen shot illustrating how a team may be summarized by the aggregated number of meetings and actions, according to one embodiment. In 1705, the number of meetings per month can be shown. In 1710, the action items queue for a team can be shown. In 1715, the recent meetings, planner, attendees, whether or not there was an agenda, action items, and ratings, can be shown. In 1720, action items completed can be shown. In 1725, upcoming meetings, planner, attendees, date and agenda items can be shown. In 1730, actions items that need to be done can be shown.

FIGS. 18-21 illustrate details related to process 200 of FIG. 2, according to one embodiment. As noted in 205 of FIG. 2, meeting details can be set up and organized, as shown in. FIG. 18. In 1805, a meeting request can be made (e.g., using MICROSOFT OUTLOOK, GOOGLE CALENDAR, or another program), with agenda items, and then the information can be sent to the meeting organization application 125 (e.g., an email to copy@invite.lessmeeting.com). For example, if Martha, Paul, Roger and Anna are attending a meeting (e.g., in person or by conference and/or video call) together, and Martha and Paul use the meeting organization application 125 installed into another program (e.g., MICROSOFT OUTLOOK), Roger can create a meeting request, with his goals, agenda, and tags in the body of the meeting request, and then include as an invitee to the meeting copy@invite.lessmeeting.com. For example, the meeting request could be as follows:

Hey guys,
This is our final meeting to review and decide between our options for the
CN903 Proposal
Goals:

| | |
|---|---|
| — | Reach a decision on new Proposal |

Agenda:

| | |
|---|---|
| 1) | Discuss Last Year's Agenda (45 mins) |
| 2) | Review Options (30 mins) |

Tags: CN903, Proposal

In 1810, the meeting organization application, can receive a copy of the meeting request, extract embedded meeting data from the meeting request (e.g., goals, agenda, tags, meeting identifier, subject, start date, start time, planner email, etc.). In 1815, the meeting organization application 125 can search for any related meetings. For example, the meeting organization application 125 can search across all known meetings for an identifier (e.g., “Meeting A”) matching this meeting. The meeting organization application can also search across all known meetings for any meetings with matching data (e.g., subject, start date, start time, planner email, where the current user (e.g., Roger) is an attendee, etc.). In 1820, if a match is found, the extracted data can be added to the meeting package associated with the related meetings. In 1816, if no matches are found, a new meeting package can be created and saved with a specific meeting identifier (e.g., a global identifier such as “Meeting A” or “12567”). The meeting package can comprise the following information: start time, end time, date, subject, location, resources, body, agenda, tasks, or other appointment details, or any combination thereof. After the meeting package is created, a system lookup record can be created matching the provided meeting identifier from a meeting request. Using the meeting identifier, each attendee and the meeting organizer can be identified and matched against known users using email addresses. The attendees and the meeting organizer can then be associated with the meeting identifier for future lookup and retrieval using a join table.

In 1825, information from the related new meetings can be extracted and added to the meeting package. For example, multiple types of searches (e.g., word searches, finding keywords (e.g., goal, agenda, tag) and searching a certain number of words after the keyword for a particular string, or searching all information after a particular keyword but before another keyword) can be done to find meetings with, for example, the same or similar goals, agenda, tags, or meeting identifier, or any combination thereof. Various items of the meeting can then be searched and parsed for additional information. For example, an agenda item can be parsed for text and matching “duration”. It should be noted that, in one embodiment, goals and agendas can be added to the meeting space using the unique meeting ID. In other embodiments, goals, agendas or any other meeting item can have their own ID, so that information about a particular goal, agenda, etc., can be tracked.

In 1830, the users (e.g., invitees, organizer, assistants, etc.) can receive the meeting request and any changes to the meeting space can be detected. Certain changes can cause the user's application (e.g., MICROSOFT OUTLOOK) receive events (e.g., updates regarding certain meeting details) upon certain changes (e.g., addition, change in time, deletion of meetings in the user's application). For example, Martha, Paul and Anna can receive the meeting request. As Martha and Paul have the meeting organization application 125 (e.g., client version) installed, details about the new meeting request can be read and it can be determined whether there are changes that need to be sent to the meeting space and/or changes that need to be communicated to users. To determine whether there are any changes, as an example, the meeting request can be compared to the previous version of the meeting request, using the meeting identifier, and it can be determined if there are any changes in the details (e.g., times, location, subject, attendees, etc). Any changes can be sent to the meeting organization application 125 (e.g., using REST protocol over SSL) and the meeting space can be updated accordingly. If a meeting identifier has not yet been created for the meeting space, or if the meeting request does not have a global identifier already associated with it, any meeting containing Martha as an attendee or Roger as the meeting planner that matches the date/time and subject of the meeting request can be identified. If a meeting is found, the meeting identifier can be added to the meeting space for this meeting so that future meeting requests can be matched more easily. (It should be noted that any meeting information by itself or in addition to other information can also be searched to identify the meeting). Changes to the meeting space can be applied when the current attendee sending the changes is designated accordingly (e.g., as a “primary” agent). This feature can help resolve different actions by various users, such as when one user deletes a meeting from their calendar, but other users are still planning on attending. The meeting organization application 125 can then resolve “who” is sending the change(s), and whether the change(s) should cause the meeting space to be updated and/or notices sent to users (e.g., attendees).

Duplicate information may include duplicated global identifiers used by different clients, merging attendee acceptance, declined and other response information from the appropriate sources, managing deletions by individuals from a calendar as opposed to cancellations of an overall meeting, managing duplicated and/or changed occurrences in a recurring meeting, managing changes to subjects, times and other key information for the same meeting when it has been synched from across clients.

As other examples of changes, information on whether the invitees accept or decline the meeting can be updated in the meeting space. For example, if the invitee (e.g., Martha) accepts the meeting request, this change event can be detected and updated in the meeting space (e.g., using the meeting identifier and/or other information). In 1840, if the invitee (e.g., Paul) declines the meeting, the meeting can be removed from this invitee's calendar and from the meeting space. In one embodiment, if all invitees and/or the organizer delete the meeting, it could be fully deleted from the invitees' calendars (or, in one embodiment, still shown but indicating that the meeting has been cancelled or deleted) and also from the meeting space. If an invitee can't make it (e.g., Paul), an invitee and/or the organizer can send out an updated meeting time. This change can be detected and the Meeting space and user calendars (e.g., for Martha and Paul who utilize the meeting organization application 125) can be updated accordingly.

It should be noted that the meeting organizer (e.g., Paul, Paul's assistant) can open a meeting request from his calendar and load the meeting plan. In some embodiments, the meeting organizer can be required to log in for security purposes. A request can then be made (e.g., using a REST call over SSL) asking for a meeting space with a certain meeting identifier and/or other information (e.g., subject, time, etc. of the current meeting). Once the meeting space is retrieved, corresponding goals, agenda and tags can be looked up using the meeting identifier. The meeting organizer can then make and save modifications (e.g., to agenda Items, goals, tags, etc.).

It should also be noted that recurring meetings can be linked together so that when a user logs into the meeting space to provide contextual history for the meeting, data can be linked using a meeting recurrence record and meeting identifier lookup table.

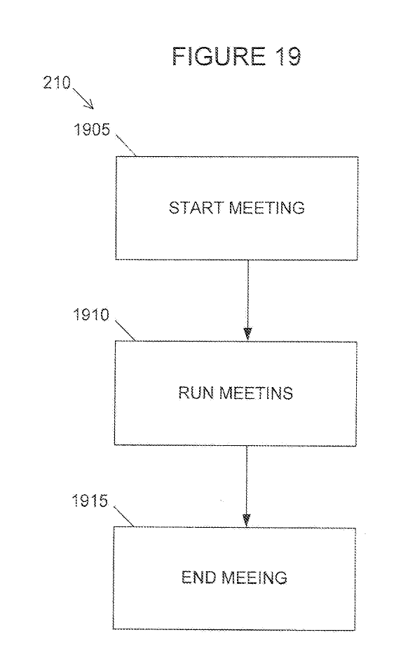

FIG. 19 illustrates details relating to the meeting taking place 210, according to one embodiment. In 1905, the organizer (e.g., Roger) can start the meeting. The organizer can do this by opening the meeting organization application 125, and logging in using his credentials. Then, all meetings can be searched for with attendee records matching the user's unique identification, and can be sorted into meetings coming up in the next week (or day, bi-week, month, etc.), and meetings which have recently occurred. It should be noted that pre-calculated data can be shown for overall time allocated to meetings for the individual, as well as % of meetings with agendas, % of meetings with minutes/notes recorded, ratings, and more. Meetings can be summarized into pre-calculated records on a regular interval, whenever meetings are detected to have changed data (or upon insertion). The time until the next meeting can also be calculated, and an indicator can be displayed if the next meeting is starting in a certain time period (e.g., the next hour, day, etc.). Once the organizer sees the right meeting (e.g., with its identifier), he can enter the meeting space. It should be noted that, in some embodiments, other users besides the organizer can start the meeting.

It should be noted that all information corresponding to the meeting space can be recalled and presented in a formatted, meeting minutes template, allowing one or more of the participants to take notes, record actions items, move conversations to a parking lot, etc.

In 1910, the meeting can be run. One participant (e.g., such as Roger, the organizer), can take notes. The first agenda item can be discussed. Roger can click into the “Notes” box for the first agenda item and type what users say. To save the notes, the user can hit enter. Upon saving the note, if the note taker has not already, the note taker can be prompted to start timing the meeting. A timer can then begin counting down the time elapsed and remaining for the meeting. Once a note is typed and/or saved, it can be added onto the page, and also saved in the meeting space. The note can be added to the meeting details, and the order and/or and structure under which the note should be stored can be saved.

Action items can also be saved. For example, if Anna volunteers to look up a proposal and send it out to the group, Roger can record this as an “action item” under the top level of the notes. He can hit“SHIFT TAB” to un-indent, and then type “@” and the names of the attendees can be auto-populated for him. After choosing Anna from the list of attendees, he can type in the action item and hit enter. The action item can then be immediately added to the page, and then sent to the meeting space to be saved, where the meeting space can associate a new action item to a note entry and to the meeting as a top level note under the first agenda Item.

When Roger decides it's time to move onto the next agenda item, he can clicks the box for the next agenda item. As time runs out for each agenda item, Roger can be notified by the clock turning yellow as it ticks down the remaining time. The time spent on each agenda item can be recorded and saved in the meeting space. Agenda items don't have to be followed sequentially, but can follow the normal flow of conversation. When the team gets off-topic, Roger can notes the off-topic items in the parking lot, in case the participants want to discuss some or all of these items later.

In 1915, the meeting is ended. As the meeting closes, the participants can review some or all of the notes at the bottom of the page. The note taker can then click “End Meeting” to stop recording the meeting time. The meeting time can be stored at the meeting space. The note taker can then click “Close Meeting” and record that the goal the team set out to achieve was successfully achieved. He can choose to send meeting minutes to all attendees of the meeting by hitting “Send Minutes”. At this point, all action items, agenda items, notes, goals, attendees and other details tied to the unique meeting space can be formatted (e.g., in HTML) and/or emailed to each individual attendee. The email can include information allowing the participants to rate the meeting. For participants that do not have the meeting organization application 125, the email can be embedded with special codes which will allow them to rate the meetings (e.g., using URLs with star images).

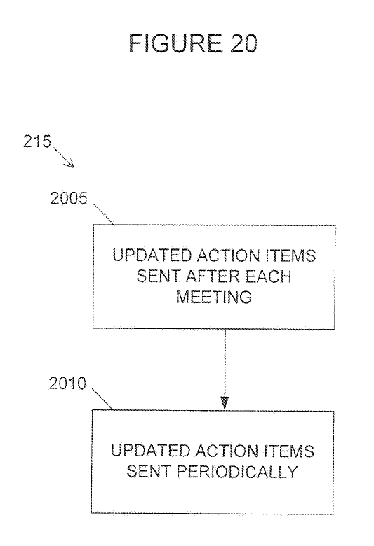

FIG. 20 illustrates details relating to meeting follow up 215, according to one embodiment. In 2005, in some embodiments, updated action items can be sent after each meeting to participants in the meeting. For example, once Paul and Martha receive meeting minutes for their last meeting, any updated action items assigned to each of them can also be sent. All actions assigned to each user can be found using the user's unique identification. All new action items (e.g., since the last sync date) can be sent to the user as part of a task list. Once a user marks an action item complete, the change can be detected and updated at the appropriate meeting space.

In 2010, in some embodiments, each person that has participated in a meeting can periodically receive an updated list of his action items (e.g., each day, each week, twice a week, etc.). This can he done for registered and non-registered users. Reminders can he based on many factors (e.g., how many days remain until the due date, when the user was last reminded of the actions, etc.).

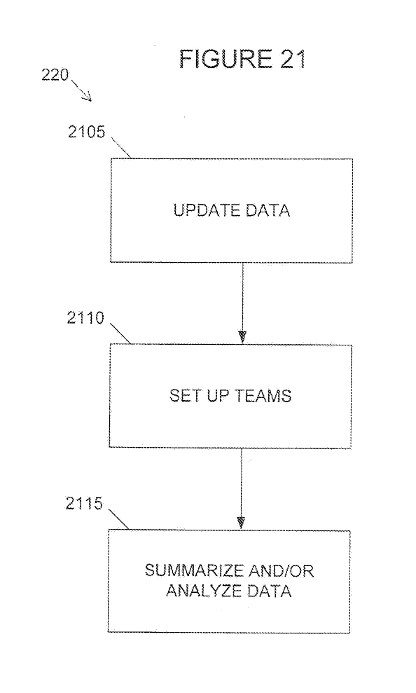

FIG. 21 illustrates details relating to meeting summary and/or analysis 220, according to one embodiment. In 2105, data can be updated. For the system to be able to extract high level patterns, all meeting space changes which have recently occurred can be detected. This can be done each day, each week, etc. All meetings which have changed can have their data (e.g., planned length of meeting, actual length of meeting, etc.) summarized. Counts of actions, goals, goals achieved, notes, and more can be calculated. A primary note taker can be determined based on who took the most notes.

In 2110, meeting teams can be defined so that team data can be summarized and/or analyzed. A team can be created by a user, and others can be invited to join. A unique team identifier and record can be created. When a user accesses the team page, the summarized meeting data and the details for each member of the team can be retrieved.

In 2115, the data can be summarized and/or analyzed by individual and/or team. The summarized meeting data can include: the number of daily hours in meetings (e.g., using summarized hours multiplied by the number of team members in the meetings), the number of daily hours with agenda items (e.g., using the meeting summary hours multiplied by a flag if there were agenda items or not), whether meetings had notes taken or not. Upcoming and recent meetings can be retrieved for the team by looking up meeting spaces with any of the team's members as attendees. Summary data such as notes taken, whether or not there were agenda items, and more can be included on a summary page. Upcoming action items, recently closed actions and overdue actions can be retrieved by looking up actions where the assigned to attendee is one of the team members, and then sifted by when they were completed, or when the due date is. Additionally, actions can be broken down by grouping them into the tags of the corresponding meetings, and by a breakdown of counts by each assignee.

It should be noted that similar data to the team data and/or other data can be pulled for each individual, when appropriate. Patterns and trends by individuals can thus be determined. For example, data for the number of meetings with different counts of agenda items can be found looking through all meeting spaces with the user as an attendee, and then grouping by the number of agenda items. Further breakdowns can be found by seeking data around how many average notes and decisions correspond to those number of agenda items, calculated by counting the associated notes for each meeting grouped by the agenda counts. Other analytical metrics can be calculated in the same manner. Patterns can be sought based on what occurs during each “hour” of time spent in meetings, by tag, and per entity (e.g., company). This data can be aggregated by looking up meeting data, and then grouping by the associated tags, attendees, and companies of attendees. This data can then be used to determine how many action items are generated on average per each meeting hour (with the person, about the tag, or with a person from that entity), how many overall meeting hours are spent on the same, and other similar data points. The average number of action items created in each Meeting with a tag or person can be determined as a “To dos per Hour” metric (or TPH). TPH can then be used to estimate future work based on who the attendees are (and their TPH rates), tags (and TPH rates), and estimated work generated by the length of meeting, agenda items, and number of attendees.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown. For example, any items in a flowchart may be performed in a different order than that indicated. In addition, any items shown in a flowchart or system diagram may be optional.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method for organizing meeting information, comprising:
performing processing related to receiving information about at least one meeting utilizing at least one computer;
performing processing related to creating at least one meeting space to represent the at least one meeting, utilizing the at least one computer;
performing processing related to integrating known information about the at least one Meeting in the at least one meeting space, utilizing the at least one computer;
performing processing related to searching for other information about the at least one meeting utilizing the at least one computer;
performing processing related to adding any additional information found about the at least one meeting in the at least one meeting space, utilizing the at least one computer; and
performing processing related to managing the at least one meeting space utilizing the at least one computer.

2. The method of claim 1, further comprising:
performing processing related to resolving any duplicate information about the at least one meeting;
performing processing related to creating at least one meeting request; or
performing processing related to combining some or all of the at least one meeting spaces into at least one linked meeting space; or
any combination thereof.

3. The meeting of claim 1, wherein:
the duplicate information comprises multiple meeting invitations; or
the managing comprises rating the effectiveness of the at least one meeting; or
any combination thereof.

4. The method of claim 1, wherein the at least one meeting space provides the ability; to take meeting notes, record at least one decision, assign at least one action item, time at least one agenda item; time at least one overall meeting, move at least one off-topic subject, take attendance at the at least one meeting, send meeting minutes to at least one attendee of the at least one meeting, or export information to at least one other application; or any combination thereof.

5. The method of claim 4, wherein the at least one other application comprises: at least one word application, at least one wiki application, at least one pdf application.

6. The method of claim 1, wherein the at least one meeting space is utilized to remind an attendee of at least one action item to complete.

7. The method of claim 6, wherein the reminder is sent: in the meeting notes, at least one reminder, or any combination thereof.

8. The method of claim 7, wherein the at least one reminder is: at least one monthly reminder, at least one weekly reminder, or at least one daily reminder, or any combination thereof.

9. The method of claim 1, wherein reminders for multiple meeting spaces can be sent to at least one user.

10. The method of claim 9, wherein all of at least one user's meeting spaces can be searched to determine which reminders to send.

11. The method of claim 6, wherein the reminders include any action items owed to at least one user and/or any action items the at least one user is responsible for completing.

12. The method of claim 1, further comprising performing processing related to analyzing personal metrics, team metrics, entity metrics, or any combination thereof.

13. The method of claim 12, wherein the personal metrics comprise:
analyzing meeting data to find patterns related to: how effective meetings are being run, agenda size, planning accuracy, actions created, or any combination thereof;
analyzing action items to determine: average times for completion of the at action items, accuracy of time assigned to action items, or action queue growth, or any combination thereof; or
analyzing meeting data to determine: where time is spent, how much activity is being generated by each person/tag/company per each meeting hour, or any combination thereof; or
any combination thereof.

14. The method of claim 12, wherein the team metrics comprise:
building teams to track meeting effectiveness and day-to-day activity across at least one level in at least one entity;
analyzing patterns across: planning, keeping meetings on track, follow-ups, high performers, or any combination thereof; or
illustrating a bird's eye view of all team's upcoming meeting activity and/or follow-ups; or
any combination thereof.

15. The method of claim 12, wherein the entity metrics comprise:
determining how an entity compares to at least one high performing entity by:
analyzing patterns across planning, keeping meetings on track, follow-ups, high performers;
analyzing duplication of efforts; or
any combination thereof.

16. The method of claim 4, wherein:
the at least one action item generates a prompt indicating that it is ready to be assigned;
the at least one action item is associated with at least one external task, and changes made to the at least one action item are synchronized with changes made to the at least one external task; or
the at least one action item generates a prompt indicating that it is ready to be assigned; or
any combination thereof.

17. A system for organizing meeting information, comprising:
at least one processor configured for:
performing processing associated with receiving information about at least one meeting;
performing processing associated with creating at least one meeting space to represent the at least one meeting;
performing processing associated with integrating known information about the at least one meeting in the at least one meeting space;
performing processing associated with searching for other information about the at least one meeting;
performing processing associated with adding any additional information found about the at least one meeting in the at least one meeting space; and
performing processing, associated with managing the at least one meeting space.

18. The system of claim 17, further comprising:
performing processing related to resolving any duplicate information about the at least one meeting;
performing processing related to creating at least one meeting request; or performing processing related to combining some or all of the at least one meeting spaces into at least one linked meeting space; or any combination thereof.

19. The system of claim 17, wherein:
the duplicate information comprises multiple meeting invitations; or
the managing comprises rating the effectiveness of the at least one meeting; or any combination thereof.

20. The system of claim 17, wherein the at least one meeting space provides the ability: to take meeting notes, record at least one decision, assign at least one action item, time at least one agenda item; time at least one overall meeting, move at least one off-topic subject, take attendance at the at least one meeting, send meeting minutes to at least one attendee of the at least one meeting, or export information to at least one other application; or any combination thereof.

21. The system of claim 20, wherein the at least one other application comprises: at least one word application, at least one wiki application, at least one pdf application.

22. The system of claim 17, wherein the at least one meeting space is utilized to remind an attendee of at least one action item to complete.

23. The system of claim 22, wherein the reminder is sent: in the meeting notes, at least one reminder, or any combination thereof.

24. The system of claim 23, wherein the at least one reminder is: at least one monthly reminder, at least one weekly reminder, or at least one daily reminder, or any combination thereof.

25. The system of claim 17, wherein reminders for multiple meeting spaces can be sent to at least one user.

26. The system of claim 25, wherein all of at least one user's meeting spaces can be searched to determine which reminders to send.

27. The system of claim 22, wherein the reminders include any action items owed to at least one user and/or any action items the at least one user is responsible for completing.

28. The system of claim 17, further comprising performing processing related to analyzing personal metrics, team metrics, entity metrics, or any combination thereof.

29. The system of claim 28, wherein the personal metrics comprise:
analyzing meeting data to find patterns related to: how effective meetings are being run, agenda size, planning accuracy, actions created, or any combination thereof;
analyzing action items to determine: average times for completion of the at action items, accuracy of time assigned to action items, or action queue growth, or any combination thereof; or
analyzing meeting, data to determine: where time is spent, how much activity is being generated by each person/tag/company per each meeting hour, or any combination thereof; or
any combination thereof.

30. The system of claim 28, wherein the team metrics comprise:
building teams to track meeting effectiveness and day-to-day activity across at least one level in at least one entity;
analyzing patterns across: planning, keeping meetings on track, follow-ups, high performers, or any combination thereof; or
illustrating a bird's eye view of all team's upcoming meeting activity and/or follow-ups; or
any combination thereof.

31. The system of claim 28, wherein the entity metrics comprise:
determining how an entity compares to at least one high performing entity by:
analyzing patterns across planning, keeping meetings on track, follow-ups, high performers;
analyzing duplication of efforts; or
any combination thereof.

32. The system of claim 20, wherein:
the at least one action item generates a prompt indicating that it is ready to be assigned;
the at least one action item is associated with at least one external task, and changes made to the at least one action item are synchronized with changes made to the at least one external task; or
the at least one action item generates a prompt indicating that it is ready to be assigned; or
any combination thereof.
